(19) United States
(12) Patent Application Publication
(10) Pub. No.: US 2025/0060228 A1
(43) Pub. Date: Feb. 20, 2025

(54) DETECTION OF DOMESTIC USES OF WATER CONSUMPTION

(71) Applicant: SUEZ GROUPE, PARIS LA DEFENSE CEDEX (FR)

(72) Inventors: Hugues HAEFFNER, BOULOGNE-BILLANCOURT (FR); Hilal DJAFRI, CERGY (FR)

(21) Appl. No.: 18/717,879

(22) PCT Filed: Dec. 9, 2022
(86) PCT No.: PCT/EP2022/085096

§ 371 Date: Jun. 7, 2024

(30) Foreign Application Priority Data
Dec. 10, 2021 (FR) FR2113328

(51) Int. Cl. G01D 4/00; E03B 7/07

(52) U.S. Cl. CPC G01D 4/00; E03B 7/072; G01D 2204/12

(57) ABSTRACT

The invention relates to a computer-implemented method comprising: obtaining a series of successive time pulses from a water consumption meter placed on a water supply pipe serving at least one home, each pulse representing the consumption of a predefined volume of water at a transmission time; the detection of a use associated with a first pulse having a transmission time greater than or equal to the sum of the transmission time of the immediately preceding pulse in the series and a predefined threshold; the successive association with the use of the immediately subsequent pulses in the series, as long as the difference between the transmission time of the last pulse associated with the use and the transmission time of the immediately subsequent pulse is less than said predefined threshold; the computation of a volume of water consumed during use, said volume of water consumed during use being equal to the number of pulses associated with the use multiplied by said predefined volume; the classification of the use into a type of use, according to said volume of water consumed during use.

### FIELD OF THE INVENTION

The present invention relates to water distribution. The present invention relates more particularly to the classification of domestic uses of water in homes.

### PRIOR ART

The preservation of water resources and the limitation of water consumption are major issues, both economically and ecologically.

One way to achieve the limitation of water consumption consists in classifying water uses, in order to quantify the respective consumptions of the different uses. It is thereby possible both to eliminate “undesirable” uses such as leaks and micro-leaks, and to identify the most consuming uses, allowing users to focus their efforts to reduce water consumption on the most significant uses.

For example, a detailed knowledge of domestic uses of water consumption makes it possible to provide the user with information such as the presence of leaks, or a particularly high consumption on a given use, e.g. particularly long showers.

Historically, such a detection of uses was impossible, because consumption was recorded over a period of at least several months by manual reading of meters, which by nature could not identify the different uses.

The emergence of water meter telemetry makes it possible to envisage new applications for the detection of uses, since, in the context of telemetry meters, consumption information can be sent to the network manager with a much finer granularity, e.g. several times a day.

However, the use of water meter telemetry is not sufficient to detect the nature of domestic water uses, for several reasons.

First, water meters generally operate by transmitting time pulses representing the consumption of a given volume of water, typically 1 liter. There is currently no effective method for classifying water uses based on the pulses.

In addition, the transmission of remote-reading frames certain limitations depending on the contexts.

First, the volume of transmitted data may in some cases be limited, which does not allow a meter to send frames containing all the pulses to a server.

There may also be limitations on data privacy. For regulatory reasons, extremely fine data about user consumption cannot always be sent. Consumptions can e.g. be sent in increments of one or several hours, or even one day.

For all the above reasons, it is often not possible for a remote-reading water meter to send all pulses to a server. It is thus desirable to be able to classify the uses locally on the meter, and only send the network operator the distribution of consumption by use.

There is thus a need for a method of classifying domestic uses of water consumption, based on pulses from a water meter.

There is also a need for a method of classifying domestic uses of water consumption that can be implemented locally on the meter.

### SUMMARY OF THE INVENTION

To this end, the subject matter of the invention relates to a computer-implemented method comprising: obtaining a series of successive time pulses from a water consumption meter placed on a water supply pipe serving at least one home, each pulse representing the consumption of a predefined volume of water at a transmission time; the detection of a use associated with a first pulse having a transmission time greater than or equal to the sum of the transmission time of the immediately preceding pulse in the series and a predefined threshold; the successive association with the use of the immediately subsequent pulses in the series, as long as the difference between the transmission time of the last pulse associated with the use and the transmission time of the immediately subsequent pulse is less than said predefined threshold; the computation of a volume of water consumed during use, said volume of water consumed during use being equal to the number of pulses associated with the use multiplied by said predefined volume; the classification of the use into a type of use, according to said volume of water consumed during use.

The method thus serves to determine the associated use from the pulses transmitted by a water meter alone. As such, the method has several advantages.

Firstly, the knowledge of uses and of the associated volumes makes it possible to better understand, and thus control, water consumption; same serves e.g., to detect undesirable uses and to know the distribution of water consumption by type of use, which leads to consumption saving.

The method according to the invention also has the advantage of not requiring a training phase for the classification of uses.

The method according to the invention requires few computational resources and can be executed on a metering device. It is thereby possible to transmit only summary data of a consumption. It is thereby possible both to limit the amount of data to be transmitted, and to preserve the confidentiality of users, by not transmitting all their consumption data.

The method according to the invention can thus be easily deployed, including on remote-reading meters with computation capacities and a limited bandwidth.

Advantageously, said predefined threshold is comprised between 40 and 180 seconds.

Such thresholds are particularly suitable for separating successive uses. Indeed, a threshold of 40 seconds serves to make sure that a low-flow use, such as a stream of water, would have generated a new pulse, whereas a threshold of 180 seconds serves to make sure that use pulses which include pauses are well aggregated in the same use.

Advantageously, said predefined threshold is comprised between 90 and 180 seconds.

Said range usually corresponds to the maximum time spent soaping up during a shower and then generating a new pulse. The threshold thus serves to aggregate all the pulses of a shower in the same use, while making it possible to fully separate the successive uses.

Advantageously, the predefined volume of water is comprised between 0.1 and 3 l.

Said values lead to a good granularity in the transmission of pulses: same are sufficiently small to transmit pulses regularly during a use, and hence to group the pulses correctly within the same use, but also sufficiently large to avoid the untimely transmission of pulses.

Advantageously, the predefined volume of water is equal to 1 l.

Said value leads to good granularity in the pulse transmission, for the reasons mentioned hereinabove. In addition, the above is the default value for many water meters. The use of said value thus makes it possible to adapt to the vast majority of meters currently deployed.

Advantageously, each type of use among a set of types of use is associated with a volume interval, the volume intervals associated with the different types of use not overlapping; said classification consists in classifying the use into a type of use of said set associated with a volume interval comprising said volume of water consumed during a use.

It is thereby possible to have a simple and efficient classification of uses into a type of use

Advantageously, the method comprises a subsequent step of calculating the cumulative volumes of water consumption respectively associated with a plurality of types of use over a given period.

It is thereby possible to directly transmit an analysis of uses, e.g. in the form of a volume of water consumption per use. The above has several advantages. As a result, it is possible to reduce the amount of data to be transmitted, which is advantageous if the metering device communicates via a low-speed radio link, which is often the case with remote-reading water meters. It is thereby also possible to preserve the confidentiality of user data, since the details of consumption are not sent.

The user or the operator of the network can thereby analyze the respective contributions of the different uses, and hence adapt their water consumption accordingly.

It is also thereby possible to identify the presence of unwanted uses.

Advantageously, the method comprises a step of presenting a synthetic graphical representation representing the cumulative volumes of water consumption associated with the plurality of types, respectively, of use over the given period, for a user living in the at least one home or an operator of the water distribution network to which said pipeline belongs.

Such a representation has the advantage of providing a synthetic and immediate view on consumption.

Advantageously, the cumulative volumes are compared with cumulative reference consumption volumes for the given period.

It is thereby possible to identify a cumulative volume of excessive consumption of a given type of use, in relation to the expected volume of consumption, and thus to refine the identification of excessive consumption on a given type of use.

Advantageously, the method comprises, if the number of occurrences or the cumulative volume of consumption of a given type of use during a given period is greater than a second threshold, the automatic detection of an undesirable use.

It is thereby possible to detect and correct unwanted uses that generate significant water consumption.

A further subject matter of the invention is a computer program product comprising program code instructions for executing the steps of the method according to one of the embodiments of the invention when said program is executed on a computer.

A further subject matter of the invention is a system comprising: a water consumption meter placed on a water supply serving at least one home configured to transmit successive time pulses, each pulse representing the consumption of a predefined volume of water at a transmission time; at least one computing unit configured to execute the steps of the method according to one of the embodiments of the invention.

Advantageously, the system comprises a single set-up comprising said water consumption meter and said at least one computing unit.

Other features, details and advantages of the invention will emerge upon reading the description made with reference to the enclosed drawings given as an example and which represent, respectively:

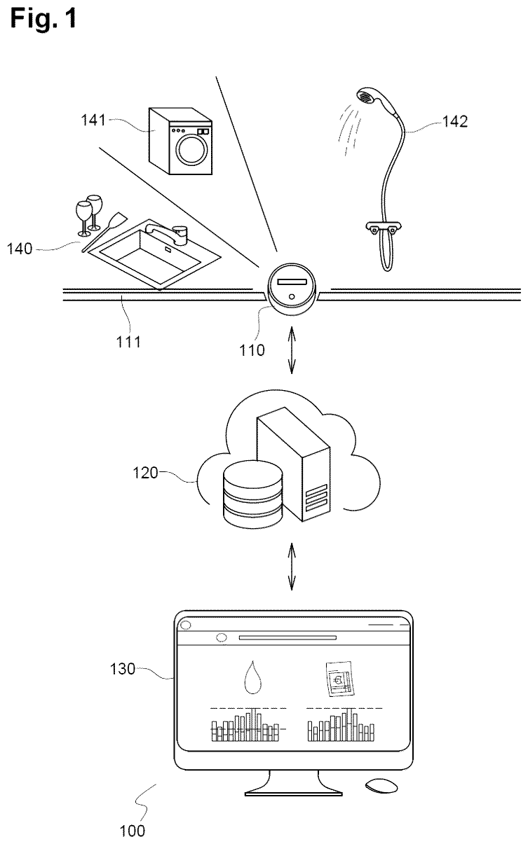

FIG. 1 shows an example of a system wherein the invention can be implemented;

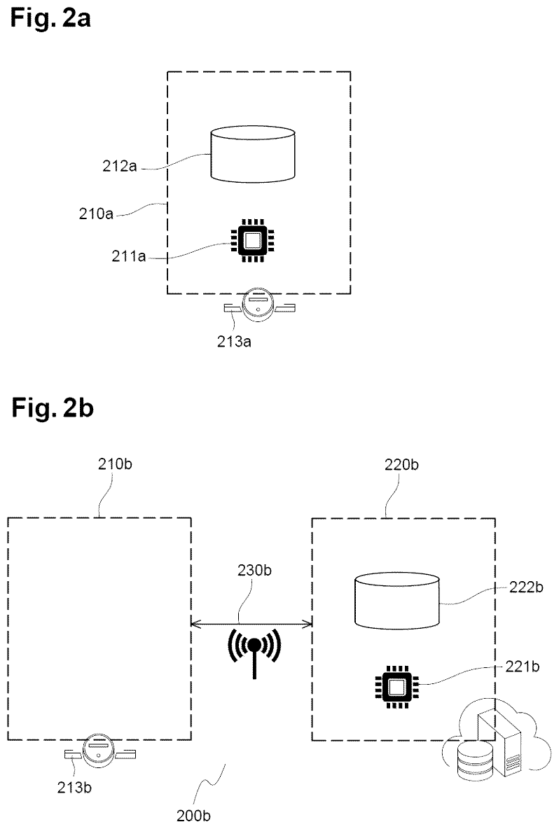

FIG. 2a shows a first example of a system according to a set of embodiments of the invention;

FIG. 2b shows a second example of a system according to a set of embodiments of the invention;

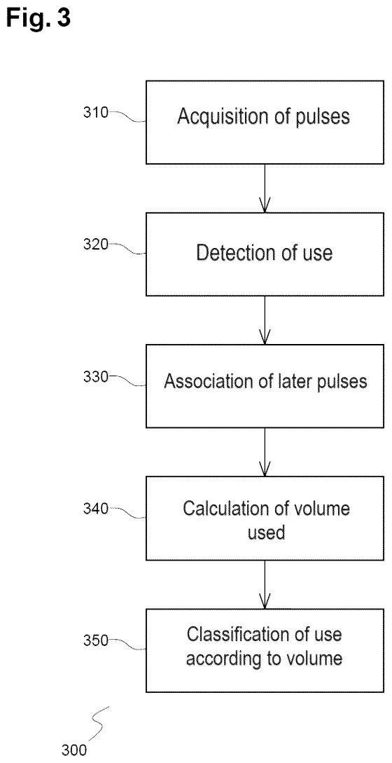

FIG. 3 shows an example of a method implemented by computer according to a set of embodiments of the invention.

FIG. 1 shows an example of a system wherein the invention can be implemented.

The system 100 comprises a water consumption meter 110 placed on a water supply pipeline 111 supplying at least one home. Home refers to a place of residence. A home can thus be e.g. an apartment, a house, a studio, a chalet, etc. According to different embodiments of the invention, the water inlet 111 can be an individual water supply line serving a single home, or a collective water supply line supplying a set of homes, e.g., a water supply line for a building.

The meter 110 is configured to measure the volume of water passing through the water supply pipeline 111, i.e. the volume of water consumed by the home(s).

To this end, the meter 110 is configured to transmit successive time pulses, each pulse representing the consumption of a predefined volume of water at a transmission time.

Thereby, the meter transmits a pulse each time a volume of water equal to the predefined volume has passed through the water supply pipeline 111. In other words, a pulse is transmitted as soon as a cumulative volume equal to the predefined volume has passed through the pipeline since the last pulse transmitted. For example, if in a given time a volume of water equal to twice the predefined volume passes through the pipeline, two pulses will be transmitted during said given time.

Each pulse is associated with a transmission time, which serves to know exactly when the pulse was transmitted. The transmission time can be represented in different ways, such as, e.g. a date and a time, a time elapsed since an initialization time of the system, or a time elapsed since the previous pulse.

According to different embodiments of the invention, the water consumption meter can be based on different principles. For example, same can be based on an electromagnetic flow-meter, or a flow sensor on which flow-rates are integrated until the volume associated with a pulse is reached.

According to different embodiments of the invention, the predefined volume can take different values. For example, the predefined volume can be comprised between 0.1 and 3 l, and can be equal to 1 l.

The water passing through the pipeline corresponds to the different consumptions of the home(s) supplied by the pipeline, and can thus be consumed for different domestic uses, such as manual dish-washing 140, the use of a washing machine 141, or else a shower 142.

One of the goals of the invention is to quantify such different uses. The above uses are given as examples only, and the invention can be used to classify and quantify any type of domestic water use.

A domestic use of water is e.g. defined by Article R214-5 of the environmental Code as follows: “A domestic use of water, as defined by Article L. 214-2, refers to intakes and discharges destined exclusively to satisfying the needs of the natural persons who own or rent the installations and the needs of the persons usually leaving under their roof, within the limits of the quantities of water needed for human consumption, hygiene care, washing and for the vegetable or animal productions reserved for the family consumption by said persons.”. Domestic uses can thus correspond to a wide range of activities using water within a home. “Undesirable” uses, such as micro-leaks, can also be considered in the case of the present invention.

In order to detect such uses, the pulses can be processed to detect the types of uses and the associated volumes.

The meter 110 may be a communicating remote-reading meter apt to communicate with at least one server 120 (called “the server” hereinafter in the description of FIG. 1) to transmit the water consumptions. Communication can be done in different ways. For example, radio communications can be used. Within the framework of communicating meters, long-distance and low-speed radio links (also known by the acronym LPWAN (Low Power Wide Area Network)), because same allow the meter to send information even if the information is not easily accessible, while involving low consumption, which allows the meter 110 to run on battery for a long time.

The server can thereby process the data received from the sensor, and communicate the data to a user terminal 130, e.g. by presenting the respective consumption shares of the different uses, or by comparing the consumptions of the different uses with the consumptions of similar households. The above allows users to better understand the structure of their water consumption, and to save the resource by focusing their reduction efforts on the highest consumptions. The user terminal may be of different types. The above may be e.g. a personal computer, a smartphone or a tablet.

According to different embodiments of the invention, the meter 110 can be an intelligent meter as such performing the classification of the uses and the estimation of the associated volumes and transmitting to the server 120 only the types of uses and the associated volumes. The above solution has the double advantage of preserving the confidentiality of the details of user consumptions and of limiting the quantity of data transmitted.

In other embodiments of the invention, the meter 110 transmits to the server 120 all the pulses, and the server 120 performs the analysis. It is thereby possible to perform an analysis for sensors that are not configured to carry out the analysis (e.g. older generation sensors), and to centralize the analysis for all sensors on the server 120 which can be used e.g. to easily adapt the analysis in the event of modifications made by the network operator in the computation parameters.

The system 100 is provided solely by way of non-limiting example of a system according to the invention, and other architectures are possible.

For example, the meter 110 can communicate directly with a user terminal 130, e.g. via a Wi-Fi or a Bluetooth link. In such case, the analysis can be done directly by the meter 110, or by the user terminal.

The system may also comprise only the meter 110. In such case, the results of the analysis can e.g. be displayed directly on the meter or stored for future use.

FIG. 2a shows a first example of a system according to a set of embodiments of the invention.

The system 200a comprises a single device 210a.

The device of 210a is a device for reading water consumption, comprising a meter 213a, which may be e.g. the meter 110.

The system 200a comprises at least one storage medium 212a. The at least one storage medium may consist of any storage medium apt to store numerical values, such as e.g. a hard disk or a flash memory. In the example shown in FIG. 2a, the at least one storage medium is located in the device 210a. In other embodiments of the invention, the at least one storage medium may be located outside the device 210a. For example, same may be a shared hard disk, or a remote database accessible through requests by the computing device. The at least one storage medium 212a can in particular be used to store the pulses transmitted by the meter 213a in preparation for the processing thereof.

The device 210a comprises at least one computing unit 211a. The computing unit may be any type of computing unit apt to load instructions and to perform computation operations. For example, the at least one computing unit may be a processor, microprocessor, microcontroller or digital signal processor (also known as a Digital Signal Processor or DSP). The at least one computational unit is not limited to any processor type or architecture and can be configured to perform operations by loading executable code elements. In a set of embodiments of the invention, the at least one computing unit may be a single computing unit, or a plurality of computing units, e.g. a plurality of processors, or a plurality of computing cores of a multi-core processor.

The at least one computing unit 211a is configured to execute the steps of a method according to the invention, such as described e.g. with reference to FIG. 3.

The execution of the method according to the invention within the water metering device 210a makes it possible to directly transmit an analysis of the uses, e.g. in the form of a volume of water consumption per use. The above has several advantages. As a result, it is possible to reduce the amount of data to be transmitted, which is advantageous if the metering device communicates via a low-speed radio link, which is often the case with remote-reading water meters. It is thereby also possible to preserve the confidentiality of user data, since the details of consumption are not sent.

FIG. 2b shows a second example of system according to a set of embodiments of the invention.

The system 200b comprises a water metering device 210b comprising a water meter 213b, and at least one computing device 220b comprising at least one computing unit 221b. The system 200b further comprises a storage medium 222b accessible by the at least one computing device 220b.

The water meter 213b, at least one computing unit 221b and storage support 222b are similar to the water meter 213a, at least one computing unit 221a and storage support 222a, respectively.

According to different embodiments of the invention, the at least one computing device 220b may consist of a single computing device, e.g. a server or a user terminal. According to other embodiments of the invention, a plurality of computing devices 220b with a plurality of computing units 221b are used. Such is the case e.g. if a plurality of servers are used.

The devices 210b and 220b communicate via a communication link 230b. The communication link may be of different types. Same may e.g. comprise one or more radio links with e.g. long-distance and low-bit rate radio links, Wi-Fi or Bluetooth links, or cellular links. The communication link may also comprise wire links.

The water metering device 210b uses the communication link 230b to transmit the pulses to at least one computing device 220b, which is responsible for performing the analysis of the pulses.

The at least one computing unit 211b is configured to execute the steps of a method according to the invention, such as e.g. described with reference to FIG. 3.

Different architectures are possible for the system 200b. For example:
the at least one computing device 220b may consist of at least one server. In such case, the device 210b may e.g. be a remote-reading meter sending to a network manager the pulses measured by the sensor 213b using a long-distance radio link;
the at least one computing device 220b may be a user terminal, e.g. a personal computer, a tablet or a smartphone. In such case, the devices 210b and 220b can communicate over a local network, e.g. via a link such as Bluetooth, Wi-Fi or Ethernet.

Performing computations on a computing device other than the metering device 210b has several advantages.

It is thereby possible to apply the method according to the invention to water metering devices that are not able to use same, e.g. metering devices from older generations. In the case where at least one computing device 220b processes the data coming from a plurality of metering devices, it is thereby possible to centralize the processing of the data. More generally, the above makes it easier to adapt the data processing method, e.g. in case of change of parameters.

In a set of embodiments not shown in FIGS. 2a and 2b, the method according to the invention is executed in part on a metering device, and in part on one or a plurality of other computing devices, e.g. a user terminal or one or a plurality of servers. For example, the metering device can generate the pulses and process same to determine associated uses and volumes, send the uses and volumes to the computing device(s), which classify the uses based on the volumes.

FIG. 3 represents an example of a method implemented by computer according to a set of embodiments of the invention.

The method 300 is a method implemented by a computer. The method can be executed e.g. by the computing units 211a or 221b. The method can also be distributed to computing units 211a and 221b, e.g. by executing part of the steps on a metering device and another part on a server. For example, steps 310 to 340 can be executed on a communicating meter which sends the associated uses and volumes to one or a plurality of servers, which execute the classification step 350.

The method 300 comprises a first step 310 of a series of obtaining successive time pulses from a water consumption meter placed on a water supply pipeline supplying at least one home, each pulse representing the consumption of a predefined volume of water at a transmission time.

The meter may be e.g. the meter 110 and the water supply pipeline 111. As explained with reference to FIG. 1, the meter is configured to transmit a pulse as soon as a volume of water equal to the predefined volume has passed through the pipeline since the previous pulse.

In a set of embodiments of the invention, the method can be executed on the metering device as such, as e.g. in the case of FIG. 2a. In such case, the pulses are directly generated and processed by the metering device.

In a set of embodiments of the invention, represented e.g. in FIG. 2b, the method is performed on a computing device distinct from the metering device. Step 310 of reception of the temporal pulses then consists in receiving the pulses from the metering device.

The method 300 then comprises a second step 320 of detection of a use associated with a first pulse having a transmission time greater than or equal to the sum of the transmission time of the immediately preceding pulse in the series and of a predefined threshold.

In other words, when a pulse is transmitted at a time sufficiently far from the previous transmission (greater than the predefined threshold), same is considered to be a new use: the new use is thus detected, and the pulse [is] associated with the use.

The method 300 then comprises a third step 330 of successively associating with the use of the immediately subsequent pulses in the series, as long as the difference between the transmission time of the last pulse associated with the use, and the transmission time of the immediately subsequent pulse, is below said predefined threshold.

In other words:
A use starts when upon the reception of the first pulse.
Iteratively, upon reception of each successive pulse:
   If the difference between the pulse and the preceding pulse is below the predefined threshold, the pulse is added to the use;
   Otherwise, the use is terminated because the delay between two successive pulses is greater than the predefined threshold, and the pulse initiates a new use.

Thereby, a use may comprise either a single pulse, if same is sufficiently far away (differences in transmission times greater than the predefined threshold) from the immediately preceding and subsequent pulses in the series, or a plurality of pulses close to each other, the difference between the transmission times of two successive pulses of the use being then always below the predefined threshold.

For example, with a predefined threshold equal to 180 seconds, one can have the following cases:
Case 1:
   First pulse i₁ at a time t₁=0 seconds;
   Second pulse i₂ at a time t₂=100 seconds;
   Third pulse i₃ at a time t₃=300 seconds;
   A first use is defined between t₁ and t₂, then a second use from t₃, because t₂−t₁<180, but t₃−t₂>180;
Case 2:
   First pulse i₁ at a time t₁=0 seconds;
   Second pulse i₂ at a time t₂=100 seconds;
   Third pulse i₃ at a time t₃=140 seconds;
   Third pulse i₄ at a time t₄=400 seconds;
   A first use is defined between t₁ and t₃, then a second use from t₄, because t₂−t₁<180, then t₃−t₂<110 but t₄−t₃>180;
Case 3:
   First pulse i₁ at a time t₁=0 seconds;
   Second pulse i₂ at a time t₂=200 seconds;
   A first use is defined at time t₁, then a second use starting from t₂, because t₂−t₁ >180;

According to different embodiments of the invention, the notion of difference below the threshold may correspond to a difference strictly lower, or lower or equal.

For example, if one considers the times tᵢ and tᵢ₊₁ of two successive pulses, the detection of a new use for with a predefined threshold S can be performed, according to different embodiments:
If the difference between tᵢ and tᵢ₊₁ is strictly less than S, i.e. if tᵢ₊₁−tᵢ<S;
If the difference between tᵢ and tᵢ₊₁ is less than or equal to S, i.e. if tᵢ₊₁−tᵢ≤S.

At the end of step 320, the pulses are thus grouped within coherent uses, corresponding e.g. to a shower, a dish [washing], etc.

According to different embodiments of the invention, the predefined threshold S can take different values.

In general, the predefined threshold represents the period of time without detectable consumption at which a use is considered to have ended. The threshold should thus be chosen low enough not to aggregate successive uses, but also high enough so that the same use is not “cut in half”. For example, it is desirable that, when a user washes their hands or showers, the water consumption before and after soaping up should be grouped together in the same use. It is thus desirable for the threshold to be sufficiently high for the last pulse before soaping up and the first pulse after to be grouped together in the same use. On the other hand, if the user gets out of the shower, gets dressed and then launches a dishwasher, it is desirable that the time without consumption during which the user dresses is greater than the predefined threshold in order to separate the two uses.

For example, the predefined threshold can be comprised e.g. between 40 and 180 seconds. A predefined threshold comprised between 90 and 180 seconds is particularly suitable.

Such thresholds are particularly suitable for separating successive uses. Indeed, a threshold greater than or equal to 40 seconds serves to make sure that a low-flow use, such as a stream of water, would have generated a new pulse in the interval of 40 seconds after the initial pulse, whereas a threshold of less than or equal to 180 seconds would serve to make sure that use pulses which include pauses are well aggregated in the same use.

More particularly, a threshold between 90 and 180 seconds generally corresponds to the maximum time spent soaping up during a shower, then running enough water again to generate a new impulse. The threshold thus serves to aggregate all the pulses of a shower in the same use, while making it possible to fully separate the successive uses.

According to different embodiments of the invention, the predefined volume of water can take different values. For example, the predefined volume can be comprised between 0.1 and 3 l.

Said values lead to a good granularity in the transmission of pulses: same are sufficiently small to transmit pulses regularly during a use, and hence to group the pulses correctly within the same use, but also sufficiently large to prevent the untimely transmission of pulses too close in time, in case of a micro-leak.

More particularly, the predefined volume of water can be equal to 1 l.

Said value leads to good granularity in the pulse transmission, for the reasons mentioned hereinabove. In addition, the above is the default value for many water meters. The use of said value thus makes it possible to adapt to the vast majority of meters currently deployed.

In a set of embodiments of the invention, the predefined threshold can be defined as a function of the predefined volume, in order to be suitable for the expected frequency of transmission of the pulses.

For example, a predefined threshold comprised between 90 and 180 seconds is particularly suitable for a predefined volume of water comprised between 0.1 and 3 l, and more particularly equal to 1 l.

The method 300 then comprises a fourth step 340 of computation of a volume of water consumed during use, said volume of water consumed during use being equal to the number of pulses associated with the use multiplied by said predefined volume.

Said step thus consists in determining the volume of a use, counting the number of pulses transmitted during the use.

For example, going back to the above example with a predefined threshold equal to 180 seconds, and a predefined volume equal to 1 l, one can have the following cases:
Case 1:
   First pulse i₁ at a time t₁=0 seconds;
   Second pulse i₂ at a time t₂=100 seconds;
   Third pulse i₃ at a time t₃=300 seconds;
   A first use is defined between t₁ and t₂, then a second use from t₃, because t₂−t₁<180, but t₃−t₂>180;
   Two pulses (i₁ and i₂) were transmitted during the first use, i.e. a volume consumed during the first use equal to 2×1 l=2 L.
Case 2:
   First pulse i₁ at a time t₁=0 seconds;
   Second pulse i₂ at a time t₂=100 seconds;
   Third pulse i₃ at a time t₃=140 seconds;
   Third pulse i₄ at a time t₄=400 seconds;
   A first use is defined between t₁ and t₃, then a second use from t₄, because t₂−t₁<180, then t₃−t₂<180 but t₄−t₃>180;
   Three pulses (i₁, i₂and i₃) were transmitted during the first use, i.e. a volume consumed during the first use equal to 3×1 l=3 l.
Case 3:
   First pulse i₁ at a time t₁=0 seconds;
   Second pulse i₂ at a time t₂=200 seconds;
   A first use is defined at time t₁, then a second use starting from t₂, because t₂−t₁>180;
   A single pulse (i₁) was transmitted during the first use, i.e. a volume consumed during the first use equal to 1×1 l=1 l.

At the end of step 340, it is thus possible to know the volume of water consumed during each use.

The method 300 then comprises a fifth step 350 of classifying the use into a type of use, according to the said volume of water consumed during the use.

Said step involves determining a type of use (e.g., if the use corresponds to a shower, dishwasher, a washing machine, etc.).

Indeed, the applicant noted that each type of use generally corresponded to a characteristic volume of water consumed. For example, a dishwasher typically consumes between 2 and 3 liters of water, a flush followed by a hand wash between 4 and 12 liters, whereas a shower typically consumes between 15 and 100 liters of water. The knowledge of the volume associated with the use thus serves to determine what type of use was concerned and, failing that, to define classes of use of interest to the user, serving to separate the main domestic uses, such as flushing, washing laundry and showers and baths

The method thus serves to determine the associated use from the pulses transmitted by a water meter alone. As such, the method has several advantages.

Firstly, the knowledge of uses and of the associated volumes makes it possible to better understand, and thus control, water consumption; same serves e.g., to detect undesirable uses and to know the distribution of water consumption by type of use, which leads to consumption saving.

The method according to the invention also has the advantage of not requiring a training phase for the classification of uses.

The method according to the invention requires few computational resources and can be executed on a metering device. It is thereby possible to transmit only summary data of a consumption. It is thereby possible both to limit the amount of data to be transmitted, and to preserve the confidentiality of users, by not transmitting all their consumption data.

The method according to the invention can thus be easily deployed, including on remote-reading meters with computation capacities and a limited bandwidth.

In one set of embodiments,
each type of use among a set of types of use is associated with a volume interval, where the volume intervals associated with the different types of use do not overlap;
said classification consists in classifying the use into a type of use of said set associated with a volume interval comprising said volume of water consumed during the use.

In other words, a number of types of use are defined, each associated with a volume interval. Where the volume of water consumed during use falls within a range associated with a type of use, the use is classified in said type.

It is thereby possible to have a simple and efficient classification of uses into a type of use.

In a set of embodiments of the invention, the classification is based on the following uses, in ascending order of volume: micro-leaks and occasional uses; controlled occasional uses such as a dishwasher; flushes; intermediate uses such as a washing machine cycle; water-saving shower; medium-length shower; water-consuming shower; bath; intensive use such as watering. The volumes associated with each use can be defined by increasing thresholds.

For this purpose, the consumption associated with each type of use can be quantified. For example, the following intervals can be evaluated:
The occasional use category of 1 l is separated in all cases (same includes micro-leaks, as well as occasional uses of 1 liter);
An occasional use of more than 1 liters ranges from 2 to 4 liters;
A flush ranges from 3 to 12 liters;
A washing machine consumes 10 to 30 liters;
A shower consumes 15 to 150 liters;
a bath consumes 80 to 250 liters.

Since some intervals overlap, thresholds can be predefined. Moreover, some intervals can be divided into more specific uses. For example, the classification can be based on the following consumption intervals, with each volume interval of water consumed by a use being associated with a type of use:
1 liter=one-time use (drawing off for a few seconds), micro-leak;
2-3 liters=controlled occasional use, dishwasher;
4-10 liters: flushes, larger draw-offs (dishes washed by hand, filling a bucket, etc.)
11-20 liters=intermediate uses (washing machine cycle, large draw-offs, very short showers);
21-40 liters=water-saving showers. (typically 5 minutes at 6 liters per minute);
40-70 liters=medium-length showers (typically 6 minutes at 8 liters per minute);
70-150 liters=long showers (typically more than 9 minutes at 8 liters per minute), half bath;
150-250 liters=baths, significant uses.
More than 250 liters=intensive use (watering, pool filling, flush blocking, continuous leak).

The above intervals and types of uses are given only as examples, but not limited to, and other intervals/types of uses may be considered. For example, a subset of the above ranges and types of use can be used. The limits and intervals considered, as well as the associated types of uses, may of course be different from same presented hereinabove. For example, different thresholds can be chosen: for example, the separation between a controlled occasional use and a flush could be defined between 2 and 3 liters rather than between 3 and 4 liters; the separation between a flush and a washing machine could be defined between 11 and 12 liters, or between 12 and 13 liters, rather than between 10 and 11; the separation threshold between a washing machine and a shower could be set between 15 and 25 liters, etc.

In the example hereinabove, the intervals cover all possible consumptions. Thereby, regardless of the volume of water consumed, a corresponding type of use can be identified. In other embodiments, the intervals associated with uses may cover only a part of the possible consumption volumes. In the case where a volume of water consumed during a use is not included in any of said intervals, the use may be classified as an unknown type of use.

In the case where data (i.e., depending on the embodiments, the transmitted data may be e.g. the pulses obtained during step 310, the uses and volumes at the end of step 340, or the classified uses, associated, where appropriate, with the volumes thereof at the end of step 350) are transmitted from a metering device to another computing device, the frequency of sending the data can be modulated. For example, data can be transmitted every hour, every day, every week, etc.

Once the uses are classified, knowing the uses can be used in a variety of ways.

In a set of embodiments of the invention, the method 300 comprises a subsequent step of computing the cumulative volumes of water consumption associated with a plurality of types of uses, respectively, over a given period.

The above consists in summing, over a given period (e.g., a week, a month, a year, etc.) the volumes consumed for each type of use. At the end of said step, the respective volumes associated with each use are thus known and can be taken into account by a user or an operator of the water distribution network.

The user or the operator of the network can thereby analyze the respective contributions of the different uses, and hence adapt their water consumption accordingly.

For example, if the analysis of cumulative volumes reveals excessive water consumption for shower-related uses, the user can adapt their consumption to reduce the time spent in the shower or adopt a more economical equipment.

It is also thereby possible to identify the presence of unwanted uses.

For example, the presence of a significant cumulative consumption associated with the “micro-leak” use serves to detect the presence of a leak, and to initiate the necessary corrective actions with a very sensitive detection threshold. Similarly, the presence of uses relating to long showers informs the user that their time spent in the shower is excessive or that their equipment should be adapted. In practice, the analysis can be carried out in different ways.

In a set of embodiments of the invention, the method 300 then comprises a step of presenting a synthetic graphical representation representing the cumulative volumes of water consumption associated with the plurality of types of use, respectively, over the given period, for a user living in at least one home or an operator of the water distribution network to which the said pipeline belongs.

In general, the uses can thereby be quantified and presented synthetically to a user and/or a network operator. For example, the relative cumulative consumption of the different types of use over a given period (week, month, year, etc.) can be presented to a user (living in one household or households concerned by the water supply) or an operator of the water distribution network supplying at least one household, e.g. in a graphical form such as a bar chart or a pie chart. The display can be done on any type of user terminal, e.g. a personal computer, a smartphone or touch-screen tablet, on a web browser or an application.

Such a representation has the advantage of providing a synthetic and immediate view on consumption.

If the representation is shown to the user, the user can directly undertake measures to adapt their water consumption.

If the representation is shown to the operator, the operator can analyze same and contact the user to inform the user of the most appropriate consumption reduction actions.

In a set of embodiments of the invention, the cumulative volumes are compared to cumulative volumes of reference consumption for the given period.

It is thereby possible to identify a cumulative volume of excessive consumption of a given type of use, in relation to the expected volume of consumption, and thus to refine the identification of excessive consumption on a given type of use.

The cumulative volumes of reference consumption for the given duration may correspond to different volumes to which it is interesting to compare the consumptions. For example, the above could be:
past cumulative consumption volumes of the same users over the same period. For example, the cumulative consumption of a home over a given month can be compared to the cumulative consumption of the same month of the previous year, which serves to detect a possible increase in consumption over a type of use;
average or median cumulative consumption volumes of equivalent households. For example, average or median cumulative consumption volumes may be established over a given region for similar households (e.g. studios occupied by a single person). It is thereby possible to detect excessive consumption on a type of use, compared to expected consumption according to the characteristics of the household supplied;
etc.

In practice, the comparison can be made in different ways. For example, cumulative consumptions can be compared numerically with reference cumulative consumptions (affected, where appropriate, by a margin factor), and an alert can be canceled if the cumulative consumption is higher than the reference cumulative consumption. If the cumulative consumption is represented graphically, the reference consumption can be indicated on the graphical representation, allowing the user or network operator to instantly compare and view the extent of excessive consumption.

In a set of embodiments of the invention, the method 300 comprises, if the number of occurrences or the cumulative volume of consumption of a given type of use during a given period is greater than a threshold, the automatic detection of an undesirable use.

An undesirable use is a use that should be limited or eliminated. For example, leaks, micro-leaks, or long showers are undesirable uses.

It is thereby possible to detect and correct unwanted uses that generate significant water consumption.

In practice, unwanted use can be detected if, for a given period:
the number of occurrences associated with the type of use is greater than a threshold. For example, a micro-leak can be detected if a number of occurrences of the “micro-leak” use (generally detected for uses with only one pulse, e.g. corresponding to a consumption of one liter of water) is greater than 20 over a day;
the cumulative volume of consumption of a use considered undesirable over a given period is above a threshold. For example, a volume associated with long showers greater than 300 liters over a week can lead to the generation of an alert.

The method thus serves to detect undesirable uses by the sole analysis of the pulses transmitted by a water meter.

The above examples demonstrate the ability of the invention to detect and classify domestic uses of water. However, same are given only as an example and in no way limit the scope of the invention, as defined in the claims hereinbelow.

1. A computer-implemented method of classifying water uses of at least one home (300) comprising:
obtaining (310) a series of successive time pulses from a water consumption meter (110) placed on a water supply pipeline (111) supplying at least one home, each pulse representing the consumption of a predefined volume of water at a transmission time;
the detection (320) of a use associated with a first pulse having a transmission time greater than or equal to the sum of the transmission time of the immediately preceding pulse in the series and of a predefined threshold;
the association (330) successively with the use of the immediately subsequent pulses in the series, as long as the difference between the transmission time of the last pulse associated with the use, and the transmission time of the immediately subsequent pulse is below said predefined threshold;
the computation (340) of a volume of water consumed during the use, said volume of water consumed during the use being equal to the number of pulses associated with the use multiplied by said predefined volume;
the classification (350) of the use into a type of use, according to the volume of water consumed during the use.

2. The method according to claim 1, wherein said predefined threshold is comprised between 40 and 180 seconds.

3. The method according to claim 2, wherein said predefined threshold is comprised between 90 and 180 seconds.

4. The method according to claim 1, wherein the predefined volume of water is comprised between 0.1 and 3 l.

5. The method according to claim 4, wherein the predefined volume of water is equal to 1 l.

6. The method according to claim 1, wherein:
each type of use among a set of types of use is associated with a volume interval, where the volume intervals associated with the different types of use do not overlap;
said classification consists in classifying the use into a type of use of said set associated with a volume interval comprising said volume of water consumed during the use.

7. The method according to claim 1, comprising a further step of computing the cumulative volumes of water consumption associated with a plurality of types of uses, respectively, over a given period.

8. The method according to claim 7, comprising a step of presenting a synthetic graphical representation representing the cumulative volumes of water consumption associated with the plurality of types, respectively, of use over the given period, for a user living in the at least one home or an operator of the water distribution network to which said pipeline belongs.

9. The method according to claim 7, wherein the cumulative volumes are compared with cumulative volumes of reference consumption for the given period.

10. A method according to claim 1 comprising, if the number of occurrences or the cumulative volume of consumption of a given type of use over a given period is greater than a second threshold, the automatic detection of an undesirable use.

11. A computer program product comprising program code instructions for executing the steps of the method according to claim 1 when said computer program is executed on a computer.

12. A classification system for water uses for at least one home (100, 200a, 200b) comprising:
a water consumption meter (110, 213a, 213b) placed on a water supply (111) supplying the at least one home, configured to transmit successive time pulses, each pulse representing the consumption of a predefined volume of water at a transmission time;
at least one computing unit (211a, 221b) configured to perform the steps of the method according to claim 1.

13. The system (200a) according to claim 12, comprising a single device (210a) comprising said water consumption meter (213a) and said at least one computing unit (211a).
